(19) United States
(12) Patent Application Publication
(10) Pub. No.: US 2015/0154784 A1
(43) Pub. Date: Jun. 4, 2015

(54) Use of Photo Animation Transitions to Mask Latency

(71) Applicants: Chase HENSEL, San Francisco, CA (US); Hector OUILHET, Mountain View, CA (US)

(72) Inventors: Chase HENSEL, San Francisco, CA (US); Hector OUILHET, Mountain View, CA (US)

(73) Assignee: Google Inc., Mountain View, CA (US)

(21) Appl. No.: 13/554,461

(22) Filed: Jul. 20, 2012

(51) Int. Cl. G09G 5/00; G06T 13/80; G06T 3/20

(52) U.S. Cl. CPC G06T 13/80; G06T 3/20

(57) ABSTRACT

Systems, methods, and computer storage mediums are provided for using photo animation transitions to mask latency. An example method includes loading a first photographic image in response to a user request. The user request is associated with a zoom-level and a set of geographic coordinates and the first photographic image is associated with a first set of image tiles. A second photographic image is requested via a network request. The second photographic image is associated with a second set of image tiles. While the network request is processed, a first animation effect is applied to the portion of the first photographic image displayed within a viewport, in which a resolution of the first photographic image is incrementally decreased for each image tile of the first set of image tiles corresponding to the portion of the first photographic image displayed within the viewport.

### BACKGROUND

1. Field

The embodiments described herein generally relate to masking latency of displaying a photographic image

2. Background Art

Digital mapping systems allow users to request information related to a geographic location and present users with photographic images in response to the requests. In such a system, a user makes a request for information related to a geographic location via a web browser. A user may make such a request by entering the name or address of a particular location. The web browser sends the request to a web server. The web server determines the boundaries of the request (e.g., coordinates, zoom-level), and retrieves the corresponding data that is usually part of a larger pre-rendered image. The images are generally associated with a significant amount of map tiles that each represent a different portion of the geographic image to be rendered. Due to the large amount of map tiles to be loaded, a user may experience a delay in viewing the requested geographic location. The delay may appear to a user as grey spots for each image tile as it is rendered, thus detracting from the overall user experience.

### BRIEF SUMMARY

The embodiments described herein include systems, methods, and computer storage mediums for masking latency of displaying a photographic image. A method, according to an embodiment, includes loading a first photographic image in response to a user request. The user request is associated with a zoom-level and a set of geographic coordinates and the first photographic image is associated with a first set of image tiles. Each image tile of the first set of image tiles represents a different portion of the first photographic image. At least a portion of the first photographic image is displayed within a viewport. The portion to be displayed is based, at least in part on the zoom-level and the set of coordinates associated with the user request. A second photographic image is requested via a network request. The second photographic image is associated with a second set of image tiles. Each image tile of the second set of image tiles represents a different portion of the second photographic image. While the network request is processed, a first animation effect is applied to the portion of the first photographic image displayed within the viewport, in which a resolution of the first photographic image is incrementally decreased for each image tile of the first set of image tiles corresponding to the portion of the first photographic image displayed within the viewport.

Further features and advantages of the embodiments described herein, as well as the structure and operation of various embodiments, are described in detail below with reference to the accompanying drawings.

### BRIEF DESCRIPTION OF THE DRAWINGS/FIGURES

Embodiments are described with reference to the accompanying drawings. In the drawings, like reference numbers may indicate identical or functionally similar elements. The drawing in which an element first appears is generally indicated by the left-most digit in the corresponding reference number.

FIG. 1A illustrates an example user interface with a first photographic image, according to an embodiment.

FIG. 1B illustrates the example user interface of FIG. 1A with an animation effect, according to an embodiment.

FIG. 1C illustrates the example user interface of FIG. 1A with a second photographic image, according to an embodiment.

FIG. 2 illustrates an example system that may be used to provide photo animation transitions to mask latency, according to an embodiment.

FIG. 3 illustrates an example image animation module that may be used to provide photo animation transitions to mask latency, according to an embodiment.

FIG. 4 is a flowchart illustrating a method for providing photo animation transitions to mask latency according to an embodiment.

FIG. 5 illustrates an example computer system in which the embodiments described herein, or portions thereof, may be implemented as computer-readable code.

### DETAILED DESCRIPTION

Embodiments described herein may be used to provide systems and methods for masking latency of displaying a photographic image. The photographic images utilized by the embodiments may include photographic images associated with a world geographical map or images captured via an image capturing device. A first photographic image is loaded in response to a user request. The user request may be associated with a zoom-level and a set of geographic coordinates and the first photographic image is associated with a first set of image tiles. Each image tile of the first set of image tiles represents a different portion of the first photographic image. At least a portion of the first photographic image is displayed within a viewport. The portion to be displayed is based, at least in part on the zoom-level and the set of coordinates included in the user request. A second photographic image is requested via a network request. The second photographic image is associated with a second set of image tiles. Each image tile of the second set of image tiles represents a different portion of the second photographic image. While the network request is processed, a first animation effect is applied to the portion of the first photographic image displayed within the viewport. The first animation can include incrementally decreasing a resolution of the first photographic image for each image tile of the first set of image tiles corresponding to the portion of the first photographic image displayed within the viewport.

In the following detailed description, references to “one embodiment,” “an embodiment,” “an example embodiment,” etc., indicate that the embodiment described may include a particular feature, structure, or characteristic. Every embodiment, however, may not necessarily include the particular feature, structure, or characteristic. Thus, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

The following detailed description refers to the accompanying drawings that illustrate example embodiments. Other embodiments are possible, and modifications can be made to the embodiments within the spirit and scope of this description. Those skilled in the art with access to the teachings provided herein will recognize additional modifications, applications, and embodiments within the scope thereof and additional fields in which embodiments would be of significant utility. Therefore, the detailed description is not meant to limit the embodiments described below.

This Detailed Description is divided into sections. The first section describes an example user interface that may be used to provide photo animation transitions to mask latency which may be performed by the embodiments. The second and third sections describe example system and method embodiments, respectively, that may be used to provide photo animation transitions to mask latency. The fourth section describes an example computer system that may be used to implement the embodiments described herein.

Example of Masking Latency of Displaying a Photographic Image

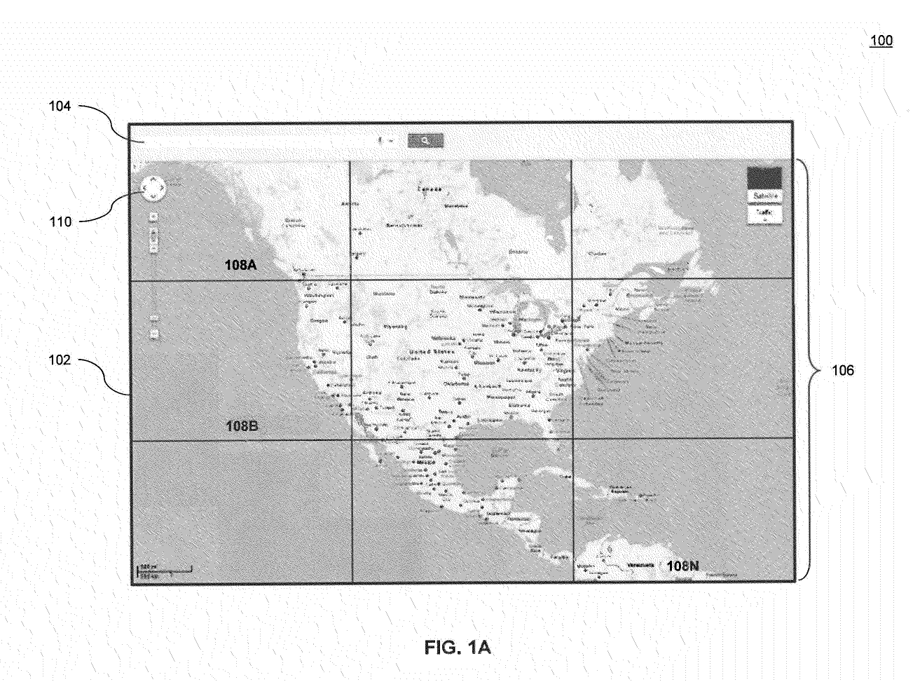

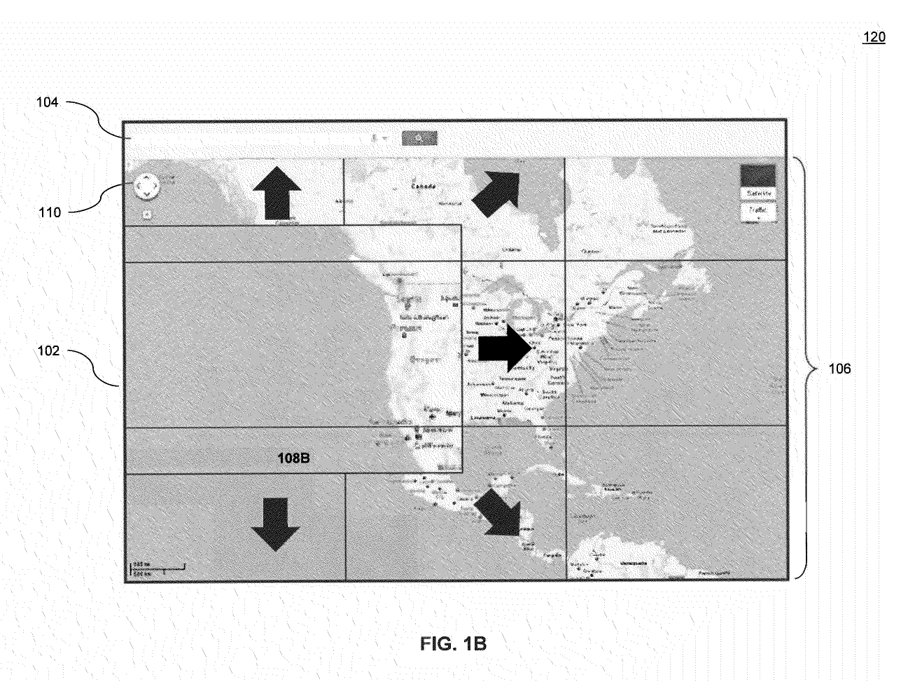

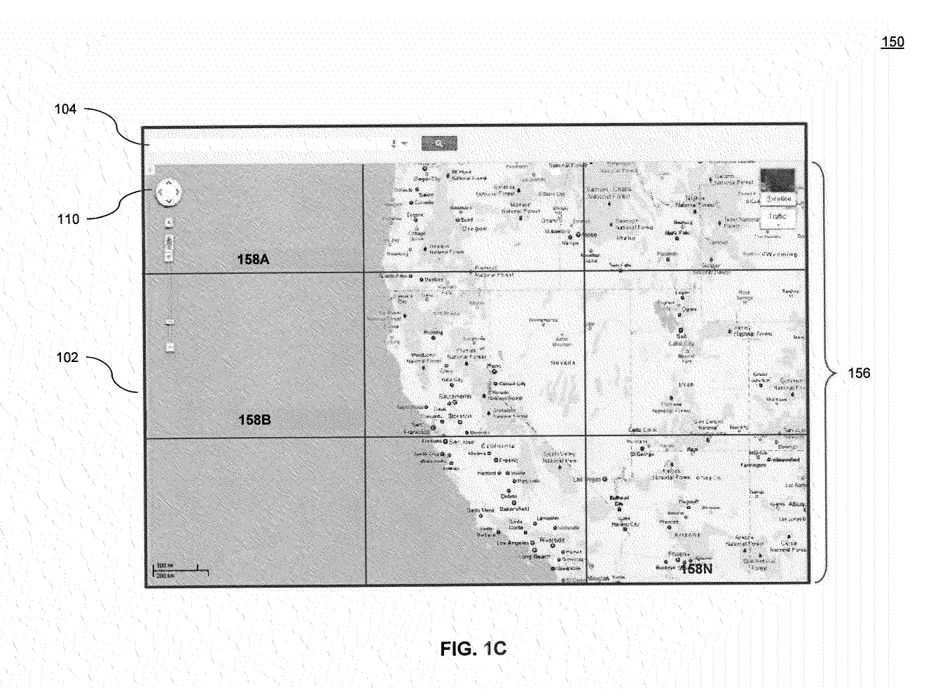

FIG. 1A illustrates an example user interface 100 with a first photographic image 106, according to an embodiment. User interface 100 may be used in some embodiments to mask latency of displaying a photographic image. User interface 100 operates as follows: The first photographic image 106 is loaded in response to a user request. The user request can be generated utilizing request entry field 104. For example, a user may enter location identifying information, such as the name of a location, the address of a location, the geographic coordinates of the location, or any other kind of information which can be used to identify a particular location. At least a portion of the first photographic image 106 is displayed within a viewport 102. In user interface 100, photographic image 106 is displayed within viewport 102 and depicts a map of portions of North America and South America. Photographic image 106 may be displayed within viewport 102 once a user enters the string “United States” within request entry field 104 or by default when the viewport loads, for example.

According to an embodiment, the first photographic image 106 is associated with a first set of image tiles. Photographic image 106 can be made up of, for example, a plurality of image tiles 108A . . . 108N. Photographic image 106 may not be an entire image, but instead can be an image or subset of an image at a particular zoom level. The zoom-level indicates a level of detail of the photographic image. In other words, photographic image 106 can be a zoomed-in portion of a larger image, meaning that viewport 102 may be used to show more detailed views of the location in photographic image 106. Typically, the more zoomed-in the view, the more detail that is shown in viewport 102. Conversely, the more zoomed-out the view, the less detail that is shown in viewport 102. Navigating within a photographic image (e.g., by panning) changes the collection of image tiles that are used for displaying the photographic image. For example, if a user pans to the right, then the image tiles neighboring the left-most image tiles in viewport 102 need to be displayed, while the right-most image tiles in viewport 102 can be removed.

In an embodiment, the user request may include a zoom-level and a set of geographic coordinates. As described above, photographic image 106 is loaded in response to a user entering location identification information within request entry field 104. However, a user may request a photographic image by other means. Zoom adjuster 110 may be used to zoom out or zoom into a photographic image. As discussed earlier, during a zoom-in or zoom-out request, a different set of image tiles are retrieved and rendered for display within viewport 102. The images tiles to be displayed are based on the zoom level requested. For example, a zoom level may be configured to be in the range of 0 through N, where 0 represents the view furthest away (lowest level of detail) and N represents the closest view (highest level of detail). Each zoom-level of a photographic image is associated with a set of image tiles. Thus, when a user zooms in or zooms out of a photographic image, the image tiles associated with the selected zoom level are rendered for display within viewport 102.

Additionally, navigation controls may be provided that allow a user to navigate within the map represented by a photographic image. For example, a user may use navigation controls to pan left, right, up or down. During such an operation, a new set of image tiles are rendered for display. The navigation controls can be configured to pan a photographic image at a predetermined rate. For example, use of the navigation controls by a user can cause the photographic image to be panned a specific number of degrees to the north, south, east or west of photographic image 106. Alternatively, a user may navigate photographic image 106 by clicking on photographic image 106 and dragging it to the left, right, up or down. Once again, a new set of image tiles will be rendered for display based on the navigation operation.

According to an embodiment, the process of rendering image tiles for display is associated with a load rate. For example, in an embodiment, the load rate can be determined by measuring a length of time it takes for all image tiles to be requested by a client device, fetched by a server, and delivered to the client device. In addition, the rendering and display of the image tiles at the client device can also be included in this measurement.

Furthermore, a user request can include a set of geographic coordinates. For example, the geographic coordinates may be the latitude and longitude of the location requested by a user based on a world geodetic system standard, such as WGS84. Since the Earth is approximately a three-dimensional sphere and the image representation of a geographic location is a flat two-dimensional surface, the photographic image is a projection of the Earth's sphere onto a flat sphere. A projection is a mapping of the latitude and longitude values into coordinates on a projection's map. In an embodiment, the projection is a Mercator projection. A Mercator projection is a cylindrical map projection in which the meridians and parallels of latitude appear as lines crossing at right angles to form a rectangular grid and in which areas appear greater farther from the equator.

According to an embodiment, displaying the first photographic image 106 includes receiving the geographic information including the zoom-level and a set of geographic coordinates based on the user request and translating the set of geographic coordinates into set of image tile coordinates. In general, mapping the geographic coordinates provided by the user request into coordinates on the projection map includes translating the geographic coordinates into world coordinates. World coordinates represent absolute locations on the projection map. Once the geographic coordinates are translated into world coordinates, the world coordinates are converted into pixel coordinates within the view.

Each map tile is associated with a tile coordinate. When a user navigates to a new location or requests a different zoom level, an application programming interface (API) determines which tiles are needed using the pixel coordinates and translates the pixel coordinates into a set of tiles to retrieve. In an embodiment, the tile coordinates can be assigned using a scheme in which the origin tile is at the northwest corner of the projection map, with the x values increasing from west to east and the y values increasing from north to south. For example, photographic image 106 includes a set of image tiles 108A . . . 108N, where image tile 108A has image tile coordinates of 0,0 and image tiles 108N has image tile coordinates of N,N.

In an embodiment, a first browser process is used to render at least a portion of a subset of the first set of image tiles associated with the first photographic image 106, according to an application programming interface (API) supported by the browser process. The subset of the first set of image tiles to be displayed is those image tiles which will be displayed within viewport 102 based on the user request. An application programming interface (API) is used to define ways to access and communicate with a software program. For example, an application programming interface (API) may define a particular set of rules and specifications that the components of the software program can follow to communicate with each other. In an embodiment, the API is a geographic information systems API.

FIG. 1C illustrates an example user interface 150 that is the same as user interface 100 in FIG. 1A except photographic image 106 is replaced by a second photographic image 156. A request for the second photographic image 156 is made via a network request. In this user interface 150, second photographic image 156 is a zoomed-in map of a portion of the United States. The second photographic image 156 is associated with a second set of image tiles 158A . . . 158N and each image tile of the second set of image tiles represent a different portion of the second photographic image 156. As described previously, a request for the second photographic image 156 can be made using at least one of request entry field 104, zoom adjuster 110, or navigation controls. For example, while viewing photographic image 106 depicting a map of the United States, a user can enter a request to view a map of Europe by typing the string “Europe” into request entry field 104. Alternatively, as shown in FIGS. 1A-C, the user may pan or zoom into photographic image 106 in order to see different portions of the United States or North America. A network request is generated to a server running the geographic mapping system. The network request results in the server retrieving the appropriate photographic image and associated image tiles from a database.

While the network request for the second photographic image is processed, a first animation effect is applied to the portion of the first photographic image displayed within the viewport 102. FIG. 1B illustrates an example user interface 120 that is the same as user interface 150 in FIG. 1C and in which an animation effect is applied to photographic image 106. The first animation effect stretches image tile 108B of photographic image 106 while the network request for second photographic image 156 is processed. In FIG. 1B, stretching image tile 108B effectively enlarges image tile 108B within viewport 102, where the image tile 108B hides the other image tiles associated with the first photographic image.

In some embodiments, applying the first animation effect includes incrementally decreasing a resolution of the first photographic image for each image tile of the first set of image tiles corresponding to the portion of the first photographic image 106 displayed within the viewport 102. Applying the first animation effect includes causing the browser process to set an animation effect attribute defined in the application programming interface (API). For example, the animated effect may be defined as a blur, which would result in the blurring of the first photographic image. Alternatively the animated effect can be defined to be one of a enlarge effect, shrink effect, dissolve effect, or slid effect, which would result in the respective enlarging, shrinking, dissolution or sliding movement of the first photographic image. The animation effect attribute is set in response to a command that triggers a request for the second photographic image 156, such as, for example, panning, zooming or entering location identification information in request entry field 104. For example, the animation effect can be set in response to a user requesting second photographic image 156 for display.

In an embodiment, a first animation effect comprises identifying one or more image tiles to be animated within the first set of image tiles. The image tiles to be animated are identified based, at least in part, on the image tiles displayed within the viewport. The client computing device and/or server can keep track of the images displayed by, for example, storing the image tile coordinates displayed within viewport 102. Once the image tiles to be animated are identified, the resolution of each of the one or more image tiles to be animated is decreased at the animation rate defined in the application programming interface. For example, the animation rate can be defined to be in the range of 0.1 seconds to 1.0 seconds. In an embodiment, the animation rate is equal to the load rate of the second photographic image 156.

As the first animation effect is applied to the one or more image tiles of the first photographic image 106, the image tiles associated with the second photographic image 156 are identified and loaded. The second photographic image 156 is not viewable to a user until all of the image tiles to be displayed are completely loaded. However, this is transparent to the user. As the image tiles associated with the second photographic image 156 are loaded, a second animation effect is applied to each of the image tiles of the second photographic image 156 to be displayed. For example, the second animation effect can be another blur effect, which blurs the images tiles associated with the second photographic image. While the second animation effect is applied, the tiles of the first photographic image 106 are shifted out of viewport 102 and the tiles to be displayed for the second photographic image 156 are shifted into viewport 102, maintaining the animation effect.

In some embodiments, when the tiles associated with the second photographic image 156 are shifted into the viewport 102, a third animation effect is applied to image tiles of the second photographic image 156. A third animation effect causes the second photographic image 156 to be viewable to a user within viewport 102. For example, the third animation effect can be an unblurring of the image times. The third animation effect incrementally increases a resolution of each of the one or more image tiles of the second photographic image 156 up to a resolution corresponding to the zoom-level requested by the user. In an embodiment, the third animation effect completes at approximately the same time as the one or more image tiles of the second photographic image 156 are shifted into the viewport 102. By applying animation techniques described above, the user experiences a seamless transition between the first and second photographic images, since the animation effects complete at a time approximately equal to the load rate for the display of the second photographic image 156. This diminishes the latency experienced by the user when the first photographic image 106 transitions to the second photographic image 156.

FIGS. 1A and 1B are provided as examples and are not intended to limit the embodiments described herein. Additionally, while embodiments are described with respect to tile-based photographic images, photographic images that are not tile-based may be requested by a user. For example, a user may request photographic images in which the photographic images are stored in JPG, TIF, PNG, or GIF format. Upon receiving a request for the photographic images an entire image or portions, thereof, may be returned in the format in which it is stored.

### Example System Embodiments

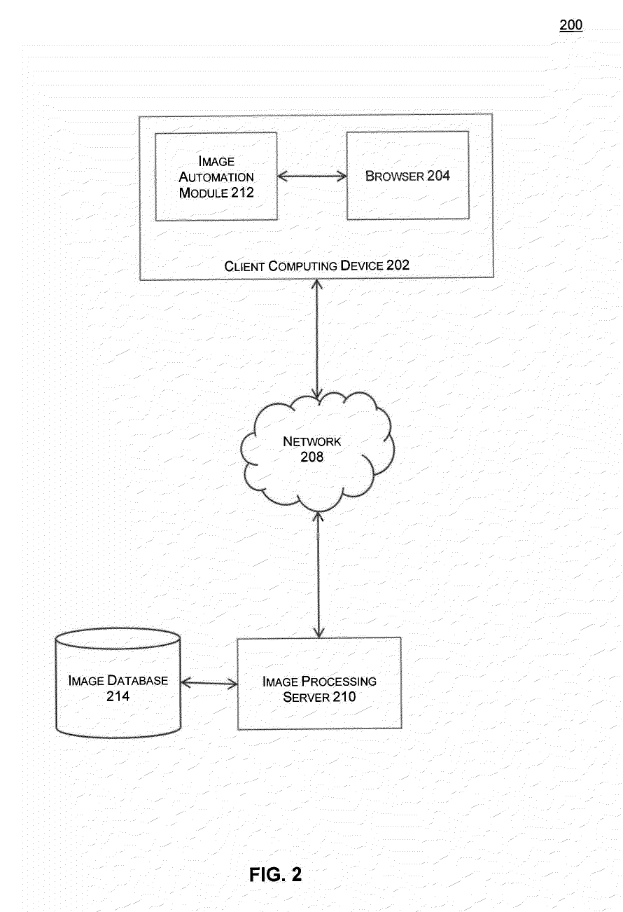

FIG. 2 illustrates an example system 200 that may be used to mask latency of displaying a photographic image, according to an embodiment. System 200 includes client computing device 202 and image processing server 210. Client computing device 202 includes browser 204 and image animation module 212. Image processing server 210 is coupled to an image database 214.

In general, system 200 operates as follows: client computing device 202 is configured to load a first photographic image in response to a user request generated via browser 204. For example, a user may access an application through browser 204, where the application is utilizing a geographic information system API. The user is able to retrieve different photographic images of maps, or photographic images of aerial or land views of a particular location. Through a user interface provided by the application, a user may enter location identifying information, such as, for example, a name, address, geographic coordinates, or any other kind of information which can be used to identify a particular location. In response to the user request, at least a portion of the first photographic image is displayed within a viewport provided by the application. For example, a map depicting portions of the United States of America may be displayed. Additionally, aerial or street-level views of specific portion of the United States may also be displayed.

The first photographic image is associated with a first set of image tiles, according to an embodiment. Image processing server 210 retrieves the first set of image tiles associated with first photographic image and sends the first set of tiles to client computing device 202 to be rendered and displayed. In general, the first photographic image is divided into a plurality of image tiles. Additionally, the first photographic image is divided into a plurality of image tiles for each zoom-level. In an embodiment, the user request, via browser 204, can include a zoom-level and a set of geographic coordinates. The zoom-level indicates a level of detail of the photographic image. The first photographic image can be zoomed into up to a predetermined maximum zoom-level. When the first photographic image is zoomed-in to the predetermined maximum zoom-level, the first photographic image is displayed at its highest level of detail. On the other hand, when the first photographic image is zoomed-out to the lowest possible zoom-level (i.e. 0), the first photographic image is displayed at its lowest level of detail. Performing a zoom operation, causes image processing server 210 to retrieve a different collection of image tiles, which are necessary for displaying the image. Alternatively, a user may navigate the first photographic image by, for example, panning. A panning operation similarly causes image processing server 210 to retrieve a different collection of image tiles that are used to display the image.

Additionally, a user request may include a set of geographic coordinates. For example, the geographic coordinates can be the latitude and longitude of the location requested by a user based on a world geodetic system standard, such as WGS84. A user may enter the name of a location, specific coordinates, or an address into an entry field provided by the application on browser 204. In response, image processing server 204 is configured to process the information received and retrieve the corresponding image tiles associated with the information provided. According to an embodiment, displaying the first photographic image includes receiving the geographic information including the zoom-level and a set of geographic coordinates based on the user request and translating the set of geographic coordinates into set of image tile coordinates. The image tile coordinates and zoom-level are used to retrieve the appropriate image tiles from image database 214.

In an embodiment, image animation module 212 is configured to render the image tiles associated with the first photographic image at a predefined load rate. For example, in an embodiment, the load rate can be the length of time it takes all of the image tiles of the first photographic image to be requested by client computing device 202, retrieved by image processing server 210, and delivered to the client computing device 202. In addition, rendering and displaying the image tiles at client computing device 202 can also be factored into the determination of the predefined load rate.

In an embodiment, browser 204 generates a first browser process in response to the user requesting the first photographic image. For example, the first browser process may be generated by the user mouse-clicking a button provided by the application, where the button is an indicator that the first photographic image is requested. Alternatively a first browser process may be generated by a user interaction with browser 204. For example, the user interaction with browser 204 can be the zoom or pan operations discussed above. At least a portion of the subset of the first set of image tiles associated with the first photographic image is retrieved by image processing server 210 and displayed within the viewport of browser 204, according to an application programming interface (API) supported by the browser process. The subset of the first set of image tiles to be displayed is those image tiles that are based on the geographic coordinates and zoom-level of the user request.

Browser 204 is configured to request a second photographic image, according to an embodiment. A request for a second photographic image is made via network 208. The request for the second photographic image is made in a similar manner as the request for the first photographic image that was described previously. The second photographic image is associated with a second set of image tiles and each image tile of the second set of image tiles represents a different portion of the second photographic image. A second photographic image can be a completely different photographic image, such as, for example, a map depicting another continent, aerial or street view. Alternatively, in this context, a second photographic image can be different portions of the first photographic image that may be retrieved via, for example, zooming or panning operations. Client computing device 202, via browser 204, generates a network request to image processing server 210 that may be running a geographic information system application that is configured to retrieve different photographic images of a location.

According to an embodiment, while the network request for the second photographic image is processed, image animation module 212 applies a first animation effect to the portion of the first photographic image displayed within the viewport of browser 204. Image animation module 212 is configured to apply the first animation effect by incrementally decreasing a resolution of all of the image tiles displayed for the first photographic image. When image processing server 210 receives an indication of the first browser process, an animation effect attribute defined in the API is set. The animation effect attribute can be one of a blur effect, dissolution effect, slide effect, enlarge effect or shrink effect. The animation effect attribute is set in response to a command that triggers a request for the second photographic image, such as, for example, panning, zooming or entering location identification information.

Image animation module 212 is configured to identify one or more image tiles to be animated within the first set of image tiles of the first photographic image. The image tiles to be animated are identified based, at least in part, on the image tiles displayed within the viewport. Once the image tiles to be animated are identified, image animation module 212 decreases the resolution of each of the one or more image tiles to be animated at the animation rate defined in the API. For example, the animation rate can be defined to be approximately equal to a load rate of the second photographic image.

According to an embodiment, as image animation module 212 applies the animation effect to the one or more image tiles of the first photographic image displayed, the image tiles associated with the second photographic image are identified by image processing server 210 and loaded by client computing device 202. In an embodiment, the second photographic image is not viewable to a user until all of the image tiles to be displayed are completely loaded. As the image tiles associated with the second photographic image are loaded, image animation module 212 applies a second animation effect to each of the image tiles of the second photographic image to be displayed. While the second animation effect is applied, image animation module 212 shifts the image tiles of the first photographic image out of view and shifts the image tiles to be displayed for the second photographic image into view, while maintaining the animation effect.

In an embodiment, when the image tiles associated with the second photographic image are shifted into the view by image animation module 212, image animation module 212 is further configured to apply a third animation effect to the image tiles of the second photographic image. For example, a third animation effect can be the un-blurring of the image tiles associated with the second photographic image. To apply the third animation effect, image animation module 212 is configured to incrementally increase a resolution of each of the one or more image tiles of the second photographic image up to a resolution corresponding to the zoom-level requested by the user. In this way image animation module 212 causes the second photographic image to be viewable to a user on browser 204. In an embodiment, image animation module 212 is configured to complete the third animation effect at approximately the same time as the one or more image tiles of the second photographic image are shifted into view. By applying the animation techniques for the first and second photographic images in combination and at approximately the same time as the loading of the images, the user experiences a seamless transition between the first and second photographic image, since the latency related to loading the second photographic image is effectively masked.

Network 208 may be any network or combination of networks that can carry data communications. Such a network 208 may include, but is not limited to, a local area network, metropolitan area network, and/or wide area network such as the Internet. Network 208 can support protocols and technology including, but not limited to, World Wide Web (or simply the “Web”), protocols such as a Hypertext Transfer Protocol (“HTTP”) protocols, and/or services. Intermediate web servers, gateways, or other servers may be provided between components of the system shown in FIG. 2, depending upon a particular application or environment.

Client computing device 202 is a processor-based electronic device that is manipulated by a user and is capable of requesting photographic images from image processing server 210 over network 208 and masking latency of the image loads. Client computing device 202 may include, for example, a mobile computing device (e.g. a mobile phone, a smart phone, a personal digital assistant (PDA), a navigation device, a tablet, or other mobile computing devices). Client computing device 202 may also include, but is not limited to, a central processing unit, an application-specific integrated circuit, a computer, workstation, a distributed computing system, a computer cluster, an embedded system, a stand-alone electronic device, a networked device, a rack server, a set-top box, or other type of computer system having at least one processor and memory. A computing process performed by a clustered computing environment or server farm may be carried out across multiple processors located at the same or different locations. Hardware can include, but is not limited to, a processor, memory, and a user interface display.

Browser 204 may be any kind of browser. Browser 204 may also include a geographic information system application (not shown). The geographic information system application may extend the functionality of browser 204 and can be configured to request photographic information related to a map from image processing server 210. For example, geographic information system application may be a browser extension downloaded from a web server and installed on client computing device 202 as part of browser 204. The geographic information system application may be developed by an application developer on client computing device 202 or any other computing device. A programming language, such as, for example, JavaScript may be used to develop the geographic information system application on client computing device 202. The geographic information system application may then be stored locally on client computing device 202. Alternatively, geographic information system application may be uploaded to image processing server 210.

Image processing server 210 can include any server system capable of retrieving image tiles associated with photographic images. Image processing server 210 may include, but is not limited to, a central processing unit, an application-specific integrated circuit, a computer, workstation, a distributed computing system, a computer cluster, an embedded system, a stand-alone electronic device, a networked device, a rack server, a set-top box, or other type of computer system having at least one processor and memory. A computing process performed by a clustered computing environment or server farm may be carried out across multiple processors located at the same or different locations. Hardware can include, but is not limited to, a processor, memory, and a user interface display. Image processing server 210 may retrieve the image tiles requested from image database 214.

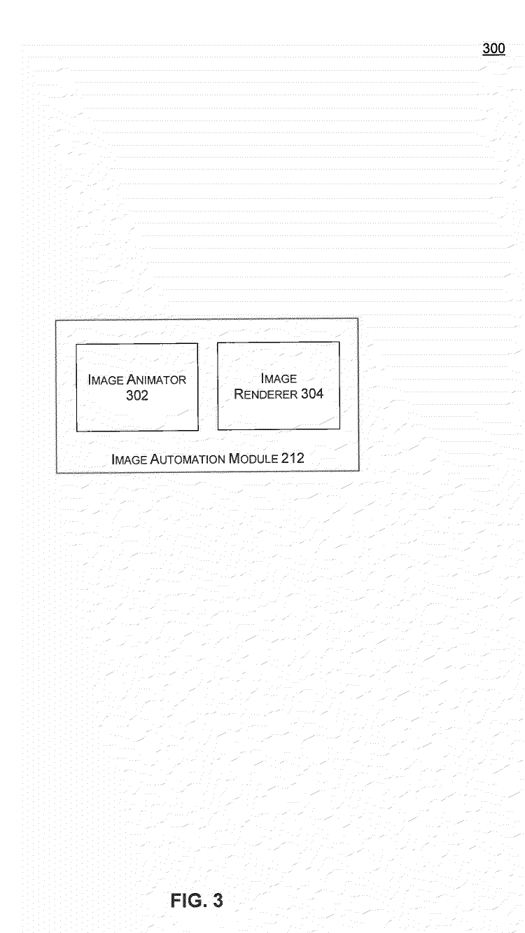

FIG. 3 illustrates an example image animation module 300, according to an embodiment. Image animation module 212 includes image animator 302 and image renderer 304.

A. Image Renderer Module

Image renderer module 304 is configured to load a first photographic image in response to a user request. The user request can be generated by a client computing device and can include a request for a photographic image related to a specific location in the world. Client computing device 202 sends location identifying information, such as, for example, the name of a location, the address of a location, the geographic coordinates of the location, or any other kind of information which can be used to identify a particular location to image processing server 210. According to an embodiment, image renderer module 304 loads at least a portion of the first photographic image so that it can be displayed on the client computing device. For example, a first photographic image may depict a map of the United States of America in addition to other portions of North America and South America.

According to an embodiment, the first photographic image is associated with a first set of image tiles. The first photographic image is divided into a plurality of image tiles for each zoom-level of the first photographic image. For instance, the first photographic image loaded by image renderer 304 can be the first photographic image at a particular zoom level. The zoom-level indicates a level of detail of the photographic image. Image renderer 304 loads the images tiles associated with a zoom-level, based in part on the user request, according to an embodiment. For example, a user request may include zoom-level information when a user performs a zoom operation on the first photographic image. Performing a zoom operation, causes image renderer 304 to load a different collection of image tiles, that are used to display the image on the client computing device. Alternatively, a user may navigate the first photographic image by, for example, panning. A palming operation similarly causes image renderer 304 to load a different collection of image tiles, that are used for displaying the image.

In an embodiment, the user request may include a set of geographic coordinates. For example, the geographic coordinates may be the latitude and longitude of the location requested by a user based on a world geodetic system standard, such as WGS84. The client computing device may provide image processing server 210 with the name of a location, specific coordinates, or an address and, in response, image processing server 210 is configured to process the information received and send the corresponding image tiles associated with the information provided to image renderer 304 to be loaded and displayed.

According to an embodiment, displaying the first photographic image includes receiving the geographic information including the zoom-level and a set of geographic coordinates based on a user request and translating the set of geographic coordinates into a set of image tile coordinates. In general, the geographic coordinates provided by the client computing device are mapped into coordinates on a projection map, where the geographic coordinates are translated into world coordinates. Once the geographic coordinates are translated into world coordinates, the world coordinates are converted into pixel coordinates and then image tile coordinates. Each map tile is associated with a tile coordinate that image processing server 210 uses to retrieve the appropriate tiles from memory. When a user requests a photographic image, an application programming interface (API) determines the tiles that are needed using the pixel coordinates and translates those values into a set of tiles to retrieve. This information is used by image processing server 210 and image renderer 304 to retrieve and load the necessary tiles, respectively.

In an embodiment, image renderer 304 is configured to render the image tiles associated with the first photographic image at a predefined load rate. For example, the load rate can be the length of time it takes all of the image tiles of the first photographic image to be requested by client computing device, retrieved by image processing server 210 from the memory and delivered to image renderer 304 to be loaded. In addition, the rendering and display of the image tiles at client computing device can also be factored into the determination of the predefined load rate.

In an embodiment, the client computing device generates a first browser process in response to the user requesting the first photographic image. For example, the first browser process may be generated by the user entering and sending specific location identification information to image renderer 304 and image processing server 210. Alternatively a first browser process may be generated by a user interaction such as, for example, the panning and zooming operations discussed above. At least a portion of the subset of the first set of image tiles associated with the first photographic image is loaded by image renderer 304 and displayed by the client computing device, according to an application programming interface (API) supported by the browser process. The subset of the first set of image tiles to be displayed is those image tiles that are based on the geographic coordinates and zoom-level of the user request.

Image renderer 304 is configured to generate a request for a second photographic image, according to an embodiment. A request for a second photographic image is made by a client computing device in a similar technique as the request for the first photographic image. The second photographic image is associated with a second set of image tiles and each image tile of the second set of image tiles may represent different portion of the second photographic image. A second photographic image can be a completely different photographic image, such as, for example, a map depicting another continent, aerial or street view. Alternatively, in this context, a second photographic image can be different portions of the first photographic image that may be retrieved via, for example, zooming or panning operations. The image renderer 304 generates a network request to image processing server 210 as an indication to retrieve different photographic images of the specified location.

A. Image Animator Module

According to an embodiment, while the network request for the second photographic image is processed by image processing server 210, image animator 302 is configured to apply a first animation effect to the portion of the first photographic image displayed. Image animator 302 is configured to incrementally decrease a resolution of all of the image tiles displayed for the first photographic image. Image animator 302 is configured to set an animation attribute and identify one or more image tiles to be animated within the first set of image tiles of the first photographic image. The image tiles to be animated are identified based, at least in part, on the image tiles displayed within the view window on the client computing device. Once the image tiles to be animated are identified, image animator 302 decreases the resolution of each of the one or more image tiles to be animated at an animation rate defined by an API. For example, the animation rate can be defined to be approximately equal to a load rate of the second photographic image.

According to an embodiment, as image animator 302 applies the first animation effect to the one or more image tiles of the first photographic image displayed, the image tiles associated with the second photographic image are identified and loaded by image renderer 304. In an embodiment, the second photographic image is not viewable to a user until all of the image tiles to be displayed are completely loaded. As the image tiles associated with the second photographic image are loaded, image animator 302 applies a second animation effect to each of the image tiles to be displayed for the second photographic image. While the second animation effect is applied, image animator 302, in combination with image renderer 304, shifts the image tiles of the first photographic image out of view and shifts the image tiles to be displayed for the second photographic image into view on the client computing device, while maintaining the animation effect.

In an embodiment, when the image tiles associated with the second photographic image are shifted into the view by image animator 302 and image renderer 304, image animator 302 is further configured to apply a third animation effect to the image tiles of the second photographic image. Image animator 302 is configured to incrementally increase a resolution of each of the one or more image tiles of the second photographic image up to a resolution corresponding to the zoom-level requested by the user. In this way, image animator 302 and image renderer 304 cause the second photographic image to be viewable to a user on the client computing device while masking latency. In an embodiment, image animator 302 is configured to complete the third animation effect at approximately the same time as the one or more image tiles of the second photographic image are shifted into view. By applying the animation and shifting techniques described above in combination and at approximately the same time, the user experiences a seamless transition between the first and second photographic images, and the latency related to loading the second photographic image is effectively masked. As a result, users will no longer see grey spots as image tiles for a photographic image are loaded, thus improving the users' experiences.

### Example Method Embodiments

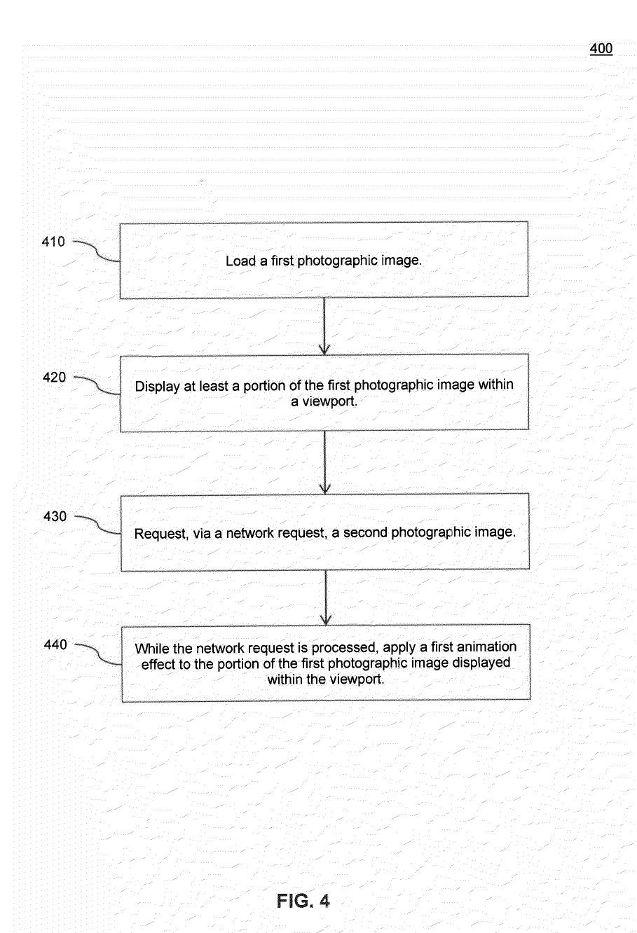

FIG. 4 is a flowchart illustrating a method 400 for masking latency of displaying a photographic image. While method 400 is described with respect to an embodiment, method 400 is not meant to be limiting and may be used in other applications. Additionally, method 400 may be carried out by, for example, system 200 in FIG. 2 or system 300 in FIG. 3.

A first photographic image is loaded at step 410. In an embodiment, the first photographic image is loaded by image animation module 212 of client computing device 202. For example, a user may access an application via client computing device 202, where the application is utilizing a geographic information system API. The user can generate a request to image processing sever 210 to retrieve different photographic images of maps, or photographic images of aerial or land views of a geographic location. Through a user interface provided by the application, a user may enter location identifying information, such as, for example, an address of a location, the geographic coordinates of the location (i.e. latitude and longitude coordinates), or any other kind of information that can be used to identify a particular location.

At step 420, at least a portion of the first photographic image is displayed within a viewport. For example step 420 may be performed by image animation module 212 of client computing device 202. In response to the user request, at least a portion of the first photographic image is retrieved by image processing server 210 and then loaded and displayed by image animation module 212 within a viewport provided by the application running on client computing device 202. The first photographic image is associated with a first set of image tiles, according to an embodiment. During step 410 of method 400, image processing server 210 retrieves the first set of image tiles associated with the first photographic image and sends the image tiles to image animation module 212 to be loaded on client computing device 202 for display. According to an embodiment, the first photographic image is divided into a plurality of image tiles. Additionally, the first photographic image is divided into a plurality of image tiles for each zoom-level.

In an embodiment, when the user generates a request from client computing device 202, the request may include a zoom-level and a set of geographic coordinates. The zoom-level indicates a level of detail of the photographic image. The first photographic image can be zoomed in to a predetermined maximum zoom-level. When the first photographic image is zoomed in to the predetermined maximum zoom-level, the first photographic image is displayed at its highest level of detail. Conversely, when the first photographic image is zoomed-out to the minimum zoom-level, the first photographic image is displayed at its lowest level of detail. Performing a zoom operation results in image processing server 210 retrieving a different collection of image tiles that are used for loading and displaying the image on client computing device 202. Alternatively, a user may navigate the first photographic image by, for example, panning. A panning operation similarly results in image processing server 210 retrieving a different collection of image tiles of the first photographic image depending on the kind of panning request.

As described above, the user request may include a set of geographic coordinates, such as, for example, the latitude and longitude. In response, image processing server 210 is configured to process the received information and retrieve the corresponding image tiles associated with the information provided. According to an embodiment, loading and displaying the first photographic image includes receiving the information from the user request including the zoom-level and a set of geographic coordinates and translating the set of geographic coordinates into set of image tile coordinates.

According to an embodiment, image animation module 212 is configured to load the image tiles associated with a photographic image at a predefined load rate. For example, in an embodiment, the load rate can be the length of time it takes all of the image tiles of photographic image to be requested by client computing device 202, retrieved by image processing server 210 from image database 214, and delivered to the client computing device 202. In addition, the loading and display of the image tiles at client computing device 202 can also be factored into the determination of the predefined load rate.

In an embodiment, a first browser process is generated by client computing device 202 in response to the user requesting the first photographic image. For example, the first browser process may be generated by the user mouse-clicking a button provided by the application, where the button provides an indication that the first photographic image is requested. The browser process will packet the information from the user request and send it to image processing server 210 for processing and retrieval of image tiles. Alternatively a first browser process can be generated by a user interaction with a browser on client computing device. For example, the user interaction with the browser can be zooming or panning operations. At least a portion of the subset of the first set of image tiles associated with the first photographic image is retrieved by image processing server 210 and loaded and displayed within a viewport of the browser running on client computing device 202. The subset of the first set of image tiles to be displayed is those image tiles that are used based on the geographic coordinates and zoom-level of the user request.

At step 430, a second photographic image is requested via a network request. In an embodiment, the request for the second photographic image is generated by client computing device 202 and received by image processing server 210. A request for a second photographic image is made by client computing device 202 via network 208. The request for the second photographic image is generated in a similar manner as the request for the first photographic image, described previously. Thus, a browser process and network request is generated by client computing device 202 that sends data packets of information to image processing server 210. The second photographic image is associated with a second set of image tiles and each image tile of the second set of image tiles represents a different portion of the second photographic image. A second photographic image can be a completely different photographic image, such as, for example, a map depicting another continent, aerial or street view. Alternatively, a second photographic image can be different portions of the first photographic image.

At step 440, while the network request for the second photographic image is processed, a first animation effect is applied to the portion of the first photographic image displayed within the viewport. For example, step 440 may be performed by image animator 302 of image animation module 212. In an embodiment, image animator 302 is configured to apply the first animation effect by incrementally decreasing a resolution of all of the image tiles displayed for the first photographic image. When image animation module 212 receives an indication of the first browser process, an animation effect attribute defined in the application programming interface (API) is set, according to an embodiment. The animation effect attribute is set in response to a command that triggers a request for the second photographic image, such as, for example, panning, zooming or entering location identification information using the application running on the client computing device 202.

Image animator 302 is further configured to identify one or more image tiles to be animated within the first set of image tiles of the first photographic image. The image tiles to be animated are identified based, at least in part, on the image tiles displayed within the viewport. Once the image tiles to be animated are identified, image animation module 212 decreases the resolution of each of the one or more image tiles to be animated at an animation rate defined in the API. For example, the animation rate can be defined to be approximately equal to a load rate of the second photographic image.

While the first animation effect is applied to the one or more image tiles of the first photographic image displayed, the image tiles associated with the second photographic image are identified and loaded. In an embodiment, the second photographic image is not viewable to a user until all of the image tiles to be displayed are completely loaded. As the image tiles associated with the second photographic image are loaded, image animation module 212 applies a second animation effect to each of the image tiles of the second photographic image to be displayed. While the second animation effect is applied, image animation module 212 shifts the image tiles of the first photographic image out of view on the client computing device 202 and shifts the image tiles to be displayed for the second photographic image into view on the client computing device 202 while maintaining the animation effect.

In an embodiment, when the image tiles associated with the second photographic image are shifted into the view by image animation module 212, image animation module 212 is further configured to apply a third animation effect to the image tiles of the second photographic image. Image animation module 212 is configured to incrementally increase a resolution of each of the one or more image tiles of the second photographic image up to a resolution corresponding to the zoom-level requested by the user. In this way image animation module 212 causes the second photographic image to be viewable to a user on client computing device 202. In an embodiment, image animation module 212 is configured to complete the third animation effect at approximately the same time as the one or more image tiles of the second photographic image are shifted into view by image processing server 210. By applying the animation techniques while transitioning between the first and second photographic, the user experiences a seamless transition between the first and second photographic images, since the latency related to loading the second photographic image is effectively masked.

Example Computer System

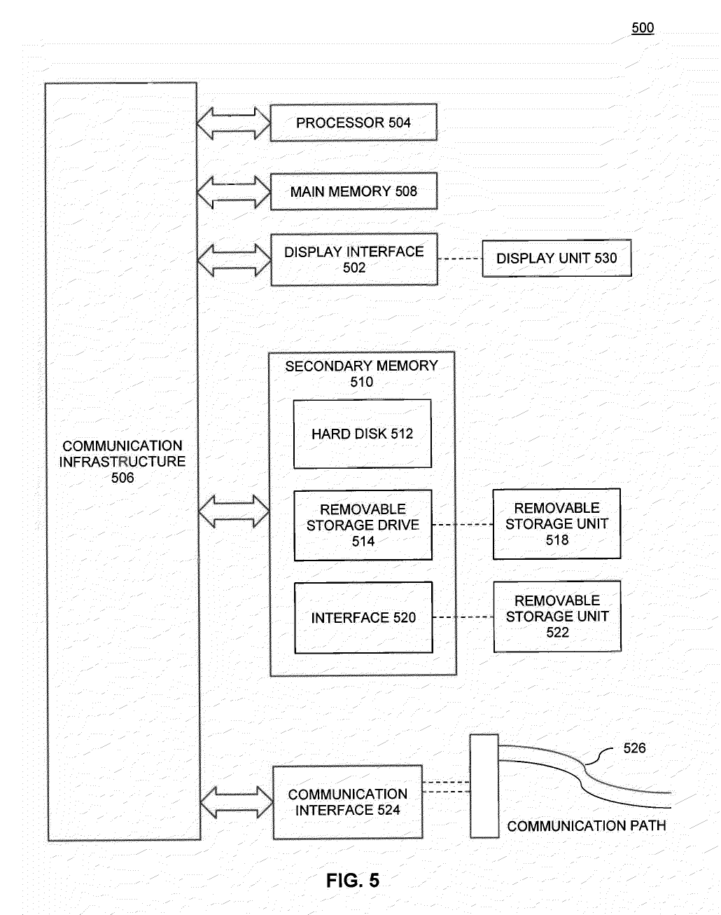

FIG. 5 illustrates an example computer 500 in which the embodiments described herein, or portions thereof, may be implemented as computer-readable code. For example, image animator 302 and image renderer 304 of image animation module 212 may be implemented in one or more computer systems 500 using hardware, software, firmware, computer readable storage media having instructions stored thereon, or a combination thereof.

One of ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device.

For instance, a computing device having at least one processor device and a memory may be used to implement the above described embodiments. A processor device may be a single processor, a plurality of processors, or combinations thereof. Processor devices may have one or more processor “cores.”

Various embodiments are described in terms of this example computer system 500. After reading this description, it will become apparent to a person skilled in the relevant art how to implement the invention using other computer systems and/or computer architectures. Although operations may be described as a sequential process, some of the operations may in fact be performed in parallel, concurrently, and/or in a distributed environment, and with program code stored locally or remotely for access by single or multiprocessor machines. In addition, in some embodiments the order of operations may be rearranged without departing from the spirit of the disclosed subject matter.

As will be appreciated by persons skilled in the relevant art, processor device 504 may be a single processor in a multi-core/multiprocessor system, such system operating alone, or in a cluster of computing devices operating in a cluster or server farm. Processor device 504 is connected to a communication infrastructure 506, for example, a bus, message queue, network, or multi-core message-passing scheme. Computer system 500 may also include display interface 502 and display unit 530.

Computer system 500 also includes a main memory 508, for example, random access memory (RAM), and may also include a secondary memory 510. Secondary memory 510 may include, for example, a hard disk drive 512, and removable storage drive 514. Removable storage drive 514 may include a floppy disk drive, a magnetic tape drive, an optical disk drive, a flash memory drive, or the like. The removable storage drive 514 reads from and/or writes to a removable storage unit 518 in a well-known manner. Removable storage unit 518 may include a floppy disk, magnetic tape, optical disk, flash memory drive, etc. which is read by and written to by removable storage drive 514. As will be appreciated by persons skilled in the relevant art, removable storage unit 518 includes a computer readable storage medium having stored thereon computer software and/or data.

In alternative implementations, secondary memory 510 may include other similar means for allowing computer programs or other instructions to be loaded into computer system 500. Such means may include, for example, a removable storage unit 522 and an interface 520. Examples of such means may include a program cartridge and cartridge interface (such as that found in video game devices), a removable memory chip (such as an EPROM, or PROM) and associated socket, and other removable storage units 522 and interfaces 520 which allow software and data to be transferred from the removable storage unit 522 to computer system 500.

Computer system 500 may also include a communications interface 524. Communications interface 524 allows software and data to be transferred between computer system 500 and external devices. Communications interface 524 may include a modem, a network interface (such as an Ethernet card), a communications port, a PCMCIA slot and card, or the like. Software and data transferred via communications interface 524 may be in the form of signals, which may be electronic, electromagnetic, optical, or other signals capable of being received by communications interface 524. These signals may be provided to communications interface 524 via a communications path 526. Communications path 526 carries signals and may be implemented using wire or cable, fiber optics, a phone line, a cellular phone link, an RF link or other communications channels.

In this document, the terms “computer storage medium” and “computer readable storage medium” are used to generally refer to media such as removable storage unit 518, removable storage unit 522, and a hard disk installed in hard disk drive 512. Computer storage medium and computer readable storage medium may also refer to memories, such as main memory 508 and secondary memory 510, which may be memory semiconductors (e.g. DRAMs, etc.).

Computer programs (also called computer control logic) are stored in main memory 508 and/or secondary memory 510. Computer programs may also be received via communications interface 524. Such computer programs, when executed, enable computer system 500 to implement the embodiments described herein. In particular, the computer programs, when executed, enable processor device 504 to implement the processes of the embodiments, such as the stages in the methods illustrated by flowchart 400 of FIG. 4, discussed above. Accordingly, such computer programs represent controllers of computer system 500. Where an embodiment is implemented using software, the software may be stored in a computer storage medium and loaded into computer system 500 using removable storage drive 514, interface 520, and hard disk drive 512, or communications interface 524.

Embodiments of the invention also may be directed to computer program products including software stored on any computer readable storage medium. Such software, when executed in one or more data processing device, causes a data processing device(s) to operate as described herein. Examples of computer readable storage mediums include, but are not limited to, primary storage devices (e.g., any type of random access memory) and secondary storage devices (e.g., hard drives, floppy disks, CD ROMS, ZIP disks, tapes, magnetic storage devices, and optical storage devices, MEMS, nanotechnological storage device, etc.).

### CONCLUSION

The Summary and Abstract sections may set forth one or more but not all embodiments as contemplated by the inventor(s), and thus, are not intended to limit the present invention and the appended claims in any way.

The foregoing description of specific embodiments so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described example embodiments.

What is claimed is:

1. A method for masking latency of displaying a photographic image, comprising:
loading a first photographic image, the first photographic image loaded in response to a user request, wherein the first photographic image is associated with a first set of image tiles, each image tile of the first set of image tiles representing a different portion of the first image, and wherein the user request is associated with a zoom-level and a set of geographic coordinates;
displaying at least a portion of the first photographic image within a viewport, wherein the displayed portion is based, at least in part, on the zoom-level and the set of geographic coordinates associated with the user request;
requesting, via a network request, a second photographic image, the second photographic image associated with a second set of image tiles, each image tile of the second set of image tiles representing a different portion of the second photographic image; and
while the network request is processed, applying a first animation effect to the portion of the first photographic image displayed within the viewport, wherein a resolution of the first photographic image is incrementally decreased for each image tile of the first set of image tiles corresponding to the portion of the first photographic image displayed within the viewport.

2. The method of claim 1, wherein displaying the first photographic image comprises:
receiving information including the zoom-level and the set of geographic coordinates based on the user request;
translating the set geographic coordinates into a set of image tile coordinates;
retrieving a subset of image tiles of the first photographic image that correspond to the image tile coordinates and zoom-level; and
utilizing a first browser process to render at least a portion of the subset of the first set of image tiles associated with the first photographic image according to an application programming interface supported by the browser process,
wherein applying first animation effect includes causing the browser process to set an animation effect attribute defined in the application programming interface, the animation effect attribute set in response to a command that triggers a request for the second photographic image.

3. The method of claim 2, wherein the command is generated in response to a user interaction with a browser, the user interaction generating a second browser process to render the second image.

4. The method of claim 1, wherein applying a first animation effect comprises:
identifying one or more image tiles to be animated within the first set of image tiles, wherein the identifying is based, at least in part, on the image tiles displayed within the viewport; and
decreasing the resolution of the one or more image tiles to be animated at an animation rate, the animation rate defined in an application programming interface, wherein the animation rate is equal to a load rate of the second photographic image.

5. The method of claim 1, wherein requesting the second photographic image comprises:
retrieving the second photographic image, an associated zoom-level, and a set of geographic coordinates, and wherein the associated zoom-level and the set of geographic coordinates identify the one or more image tiles of the second set of image tiles to be loaded; and
loading the identified one or more image tiles of the second photographic image while the first animation effect is applied to the one or more image tiles of the first image, wherein the second photographic image is not displayed until each of the one or more identified image tiles are loaded.

6. The method of claim 5, further comprising:
applying a second animation effect to the identified one or more image tiles of the second photographic image;
while the second animation effect is applied, shifting the tiles associated with the first photographic image out of the viewport;
while the tiles associated with the first photographic image are shifted, shifting the one or more image tiles of second image into the viewport, the one or more tiles of the second image maintaining the animation effect;
applying a third animation effect to the one or more image tiles of the second image, wherein the third animation effect causes the second image to be viewable to a user within the viewport; and
displaying at least a portion of the second photographic image within the viewport, wherein the portion to be displayed is based on the associated zoom-level and set of geographic coordinates.

7. The method of claim 6, wherein applying a third animation effect comprises:
incrementally increasing a resolution of each of the one or more image tiles of the second photographic image up to a resolution corresponding to the zoom-level, wherein applying the third animation effect completes at approximately the same time as the one or more image tiles of the second photographic image are shifted into the viewport.

8. The method of claim 1, wherein the first and second photographic images correspond to a location in a two dimensional geodetic map.

9. The method of claim 1, wherein the zoom level indicates a level of detail used to display the first photographic image.

10. A computer system comprising:
a memory;
an image renderer coupled to the memory and configured to load a first photographic image from the memory, the first photographic image loaded in response to a user request, wherein the first photographic image is associated with a first set of image tiles, each image tile of the first set of image tiles representing a different portion of the first image and wherein the user request is associated with a zoom-level and a set of geographic coordinates and display at least a portion of the first photographic image within a viewport, wherein the displayed portion is based, at least in part, on the zoom-level and the set of geographic coordinates associated with the user request;
a user interface configured to generate a network request, via a network connection, a second photographic image from the memory, the second photographic image associated with a second set of image tiles, each image tile of the second set of image tiles representing a different portion of the second photographic image; and
an image animator configured to apply a first animation effect to the portion of the first photographic image displayed within the viewport while the network request is processed, wherein a resolution is incrementally decreased for each image tile of the first set of image tiles corresponding to the portion of the first photographic image displayed within the viewport.

11. The system of claim 10, wherein the image renderer is further configured to receive information including the zoom-level and set of geographic coordinates based on the user request, translate the set geographic coordinates into a set of image tile coordinates, and retrieve a subset of image tiles of the first photographic image that correspond to the image tile coordinates and zoom-level, utilize a first browser process to render at least a portion of the subset of the first image according to an application programming interface supported by the browser process, and wherein the image animator is further configured to apply the first animation effect by causing the first browser process to set an animation effect attribute defined in the application programming interface, the animation effect attribute set in response to a command that triggers a request for the second photographic image.

12. The system of claim 11, wherein the command is generated in response to a user interaction with a browser, the user interaction generating a second browser process to render the second photographic image.

13. The system of claim 10, wherein the image animator is further configured to identify one or more image tiles to be animated within the first set of image tiles, an identification based on the image tiles displayed within the viewport; and decrease the resolution of the one or more image tiles to be animated at an animation rate, the animation rate defined in an application programming interface, wherein the animation rate is equal to a load rate of the second photographic image.

14. The system of claim 10, wherein the image renderer is further configured to retrieve the second photographic image from the memory, wherein the request for the second photographic image includes an associated zoom-level and set of geographic coordinates, and further wherein the associated zoom-level and set of geographic coordinates identify the one or more image tiles of the second set of image tiles to be loaded, and load the identified one or more image tiles of the second photographic image while the first animation effect is applied to the one or more image tiles of the first image, wherein the second photographic image is not viewable to a user until all the one or more identified image tiles are completely loaded.

15. The system of claim 14, wherein the image animator is further configured to apply a second animation effect to the identified one or more image tiles of the second photographic image, shift the tiles associated with the first photographic image out of the viewport while the second animation effect is applied, shift the one or more image tiles of second photographic image into the viewport while the tiles associated with the first photographic image are shifted, and apply a third animation effect to the one or more image tiles of the second photographic image, wherein the third animation effect causes the second photographic image to be viewable to a user within the viewport.

16. The system of claim 15, wherein the image animator is further configured to incrementally increase a resolution of each of the one or more image tiles of the second photographic image up to the zoom-level, wherein the third animation effect is complete at the same time the one or more image tiles are shifted into the viewport.

17. The system of claim 10, wherein the first and second photographic images correspond to a location in a two dimensional geodetic map.

18. The system of claim 10, wherein the zoom level determines a level of detail to display the first photographic image.

19. A non-transitory computer-readable storage medium having instructions encoded thereon that, when executed by a computing device, cause the computing device to perform operations comprising:
requesting, via a network connection, a second photographic image from a memory device while a first photographic image is displayed within a viewport, the second photographic image associated with a second set of image tiles, each image tile of the second set of image tiles representing a different portion of the second photographic image; and
while the request is pending, applying a first animation effect to the portion of the first photographic image displayed within the viewport.

20. The non-transitory computer-readable storage medium of claim 19, wherein the instructions cause the computer to perform operations further comprising:
receiving information including the zoom-level and set of geographic coordinates based on the user request;
translating the set geographic coordinates into a set of image tile coordinates;
retrieving a subset of image tiles of the second photographic image corresponding to the image tile coordinates and zoom-level; and
utilizing a first browser process to render the subset of the second set of image tiles associated with the second photographic image according to an application programming interface supported by the browser process, and
wherein the first animation effect is applied to the first photographic image by causing the browser process to set an animation effect attribute defined in the application programming interface, the animation effect attribute set in response to a command, the command triggering a request for the second photographic image.
